(19) United States
(12) Patent Application Publication
(10) Pub. No.: US 2003/0042339 A1
(43) Pub. Date: Mar. 6, 2003

(54) Spray-coating system

(75) Inventor: Manfred Dankert, Rodenmark (DE)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ITW Oberflachentechnik GmbH & Co. KG

(21) Appl. No.: 10/227,457

(22) Filed: Aug. 26, 2002

(30) Foreign Application Priority Data
Aug. 29, 2001 (DE) 101 42 074.9

(51) Int. Cl. B05B 1/00

(52) U.S. Cl. 239/600; 239/390

(57) ABSTRACT

A spray-coating system comprising a spraying implement (2) affixable to a support (4) by a tightening element (26) which is affixed to one of said part (2, 4) so as to be rotatable relative to both parts (2, 4).

The present invention relates to a spray-coating system defined in the preamble of claim 1.

Accordingly the invention relates to the spray-coating system containing a spraying implement, a support to which the spraying implement may be affixed in detachable manner by clamping means, first fluid-transmitting duct ends of fluid-transmitting ducts in the support configured opposite other, second fluid-transmitting duct ends of other fluid-transmitting ducts in the spraying implement and serving to convey fluids in-between when the spraying implement is affixed to the support, further containing seals at the fluid-transmitting duct ends to mutually seal the support and the spraying implement, said clamping means allowing to clamp the spraying implement against the support and the in-between seals being compressed.

The spray-coating system is especially well suited for spray-coating using liquid coating materials, through it also may be designed to spray-coat powders conveyed in a pressurized-gas flow, preferably a flow of compressed air.

A spray-coating system of this kind is known from the European patent document 0 846 498 A1. Therein, instead of a separately rotatable tightening element, it is the spraying implement itself which rotates in order to rotate a tightening element which is affixed to it relative to a support in order to clamp the latter two elements. In the course of this rotation, O rings between said implement and support being clamped in fluid-transmitting duct ends they contain. These seals only partly enter recesses in the spraying implement. The transverse motions taking place during clamping and releasing will abrasively shear said seals. Accordingly these seals must be exchanged on account of wear after the spraying implement has been mounted on and removed from the support several times. The support is in the form of an adapter's plate which can be screwed tightly on a rest. This adapter makes it possible to affix the same or different spray-coating devices all designed with the same configuration of fluid-transmitting duct ends to a number of different rests such as robot arms or jacks exhibiting different configurations of fluid-transmitting ducts, and the same control programs may be used in all applications to drive the spray-coating system.

The objective of the invention is to reduce the seal wear between the spraying implement and the support in simple and economical manner and thereby to extend seal life and to preclude leakage flows when the coating material or other fluids, for instance compressed air or gas, solvents etc. are highly pressurized.

This goal is attained by the featured of claim 1 of the present invention.

As stated therein, the clamping means comprise a tightening element which is affixed to either of the group of spraying implement and support so as to be rotatable relative to it and comprises a first clamping surface, a second clamping surface being present at the other of said spraying implement or support, the axis of rotation of said tightening element being in the direction of tightening wherein the spraying implement and the support may be clamped against each other, and rotation of the tightening element relative said spraying implement and support allows rotating the first clamping surface while being clamped to the second clamping surface in order to clamp the spraying implement against the support and thereby to clamp the seals in-between.

The dependent claims contain further features of the invention.

Both in the present specification and the claims, the term “fluid” is considered in its basic form including especially “liquids”, in particular coating liquids or a solvent, gases, especially compressed air, and a flow of compressed air containing coating powder.

The invention is elucidated below by means of a preferred embodiment and in relation to the attached drawings.

FIG. 1 is an bottom view of the spray-coating system of the invention showing the superposed spraying implement and support as yet not clamped to each other, and a tightening element in an angular position of separation,

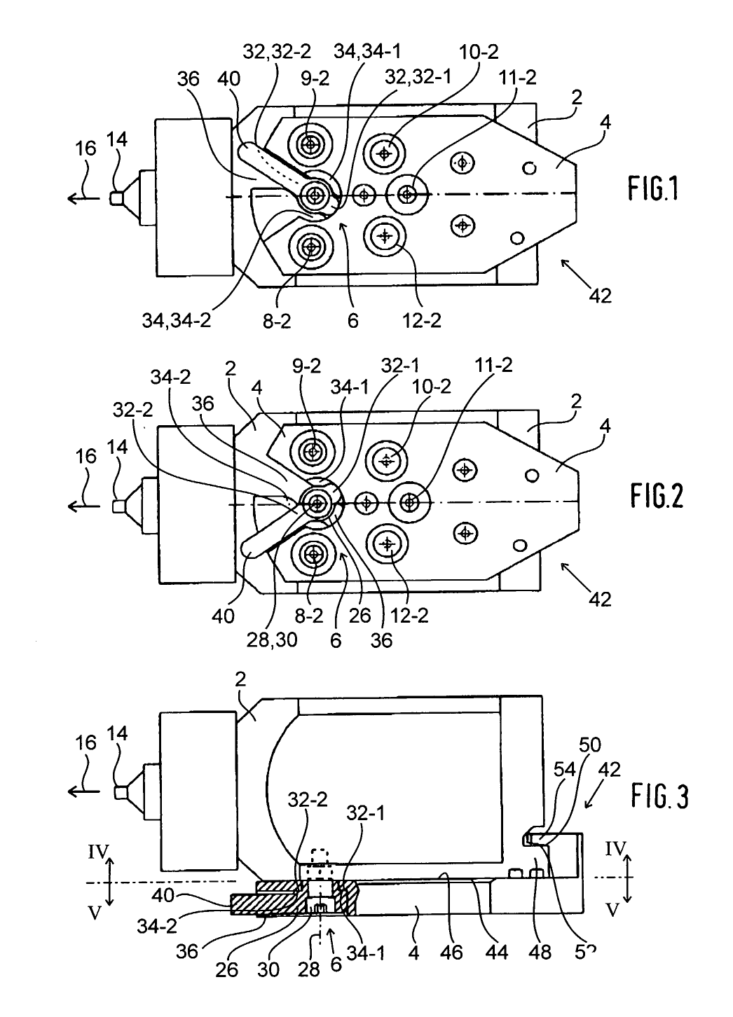

FIG. 2 is a bottom view of the spray-coating system of the invention, the spraying implement being clamped to the support on account of the tightening element having been rotated relatively both to the spraying implement and the support into the angular position of clamping,

FIG. 3 is a sideview of the coat-spraying device of the invention wherein the spraying implement was partly clamped onto the support but a tightening element has not yet reached its final clamped angular position of FIG. 2,

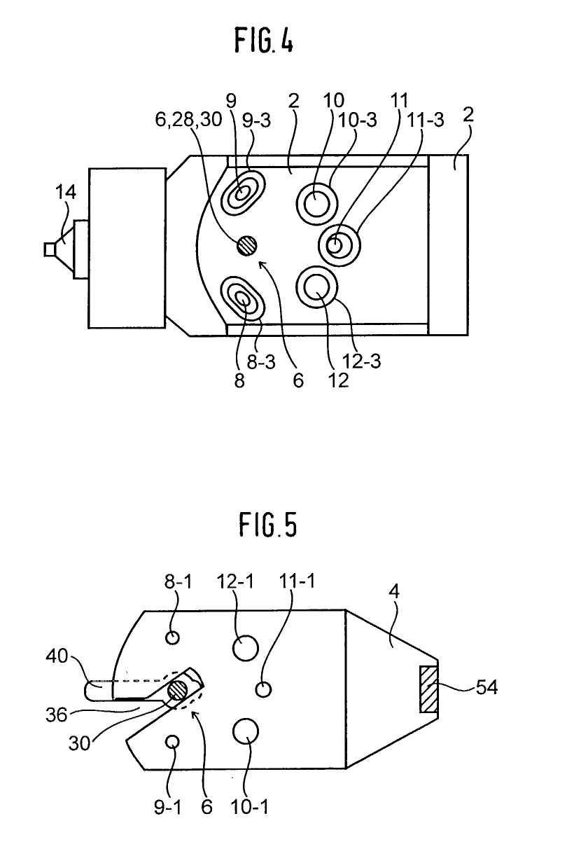

FIG. 4 is a bottom view of the spraying implement along the plane IV-IV of FIG. 3, without the support, and

FIG. 5 is a topview of the support along the plane V-V of FIG. 3.

The spray-coating system of the invention shown in the drawings is designed to spray a liquid coating material, for instance varnish. In another embodiment, it may be used to spray pneumatically conveyed powder coating material.

The spray-coating system of the invention contains a spraying implement 2 and a support 4 which are detachably affixed to each other by clamps 6. Furthermore fluid-transmitting duct ends 8, 9, 10, 11 and 12 in the form of boreholes or similar apertures are fitted in the spraying implement 2 and are opposite respectively fluid-transmitting duct ends 8-1, 9-1, 10-1, 11-1 and 12-1 for fluid transmission between them when the spraying implement 2 is clamped against and thus affixed to the support 4. The fluid-transmitting ducts in the support 4 also consist of boreholes or similar apertures. As shown in the drawings, the spraying implement 2 is substantially rectangular and preferably made of plastic or metal and comprises at its front end a spray nozzle 14 to spray the coating material 16 in the direction of the arrow 16. Preferably the support 4 shall also be made of plastic or metal and it assumes the form of an adapter plate of an omitted adapter serving to geometrically match the fluid-transmitting duct ends 8, 9, 10, 11 and 12 of the spraying implement 2 to the geometric array of fluid lines of a rest to which the adapter may be affixed and which illustratively may be a robot arm or raising support. As a result, different geometric configurations of fluid lines of such a support do not entail different spraying implements, but instead the same spraying implement may always be used or different spraying implements with the same configuration of fluid-transmitting ducts of said rest may always be used by resort to different adapters. Consequently the same operational, i.e. computer, program for the spraying implement 2 may be used for different geometric line configurations.

The fluid-transmitting duct ends 8, 9, 10, 11 and 12 of the spraying implement 2 are shown in FIG. 4 and the fluid-transmitting duct ends 8-1, 9-1, 10-1, 11-1 and 12-1 of the plate support 4 and aligned with the former respective fluid-transmitting duct ends are shown in FIG. 5. On the pertinent side of the support 4, FIGS. 1 and 3 show the associated outer fluid-transmitting duct ends 8-2, 9-2, 10-2, 11-2 and 12-2 of the fluid-transmitting ducts configured in the support 4, said latter ducts when hooked up to an omitted rest being connected for fluid transmission with fluid lines fitted on or in the said rest.

Within the scope of the present invention, the term “fluid” may denote a liquid, in particular a coating liquid or a solvent, a gas, for instance compressed air, a mixture of compressed air and powder used as a coating material or another medium able to flow. In the preferred embodiment, which is the one shown in the drawings, the fluid line of the fluid-transmitting duct end 8 serves as the feed of coating material into the spraying element 2; the fluid-transmitting duct end 9 is used for the return of coating material from the spraying implement 2 during pauses in spray coating; the fluid-transmitting duct end 10 is used for atomizing air to assist the atomization of the coating material at the spray nozzle 14; the fluid-transmitting duct end 11 is used for compressed-air control to drive an omitted valve contained in the spraying implement, the coating material being able to flow from the feed fluid-transmitting duct end 8 when said valve is opened toward the spray nozzle 14, and, when said valve is in its closed position, the coating material is thereby able to flow from the feed fluid-transmitting duct end 8 to the return fluid-transmitting duct end 9 instead of toward the spray nozzle 14, in the manner for instance known from the European patent document 0 846 498 A1 of which the disclosure is incorporated herein; the fluid-transmitting duct end 12 is for air shaping, where said air, in order to shape the spray jet, is allowed to flow around the aperture of the nozzle 14 in the manner already known for instance from the above cited European patent document 0 846 498 A1.

A seal in the form of an 0 ring 8-3, 9-3, 10-3, 11-3 and 12-3 is respectively mounted between the fluid-transmitting duct ends 8 and 8-1, 9 and 9-1, 10 and 10-1, 11 and 11-1, 12 and 12-1. These seals may be mounted in recessed manner in offsets of the fluid-transmitting ducts of either of the spraying implement 2 and support 4, preferably they shall be configured in the spraying implement 2 and shall slightly project from said implement's surface 44 for instance by 0.1 to 0.5 mm in order to seal against pressurized fluid in leakage proof manner when the spraying implement 2 and the support 4 are mutually compressed. Preferably the seals are made of a resilient, material compressible material such as rubber.

The spraying implement 2 is affixed to the support 4 by being compressed by the clamping means 6 against this support 4, the sandwiched seals 8-3 through 12-3 thereby being compressed.

The clamping means contains a tightening element 26 rotatable relative to both the spraying implement 2 and the support 4 about an axis of rotation 28 which is subtended parallel to the direction of clamping by a screw 30 allowing to rotatably affix the tightening element 26 to the spraying implement 2 on the side facing the support 4. In another embodiment, the tightening element 26 is rotatably affixed not to the spraying implement 2 but to the support 4. In the longitudinal direction of the axis of rotation and at a gap from the spraying implement 2, the tightening element 26 comprises a first clamping surface 32 running and extending transversely to the axis of rotation 28 and pointing toward the spraying implement 2. A second clamping surface 34 is constituted at the support 4 and points away from the spraying element 2. Preferably each clamping surface 32 and 34 consists of two partial-surfaces 32-1 and 32-2 and 34-1 and 34-2 respectively which are configured approximately diametrically to each with respect to the axis of rotation.

A recess 36 is subtended in the support 4 next to the second clamping surface 34 and allows passing the tightening element 26 in the longitudinal direction of the axis of rotation 28 when the spraying implement 2 is set on the support 4, whereby both clamping surfaces 32 and 34 come to assume an adjacent position in an angular position of separation corresponding to FIG. 1, whereupon, when the tightening element 26 shall be rotated into the angular position of clamping of FIG. 2, its first clamping surface 32 can be rotated onto the second clamping surface 34 of the support 4. In this process the spraying implement 2 is drawn against the tightening element 26 and the sandwiched O-rings 8-3 through 12-3 shall be compressed.

When said seals are made of a soft, resilient material, they may be compressed manually between the spraying implement 2 and the support 4 in a manner that the two clamping surfaces 32 and 34 may be mutually rotated from a height-offset mutual position which does not overlap into a mutual position which does overlap. In that case the clamping surfaces 32 and 34 may be planes running in a plane that is radial to the axis of rotation 28. More practically, however and especially in the case the seals consist of a harder material, one or both clamping surfaces 32 and 34 ascending like a thread around the axis of rotation 28 or pointing toward the other clamping surface in order that by manually rotating the tightening element 26 the spraying implement 2 shall be drawn, against the opposing force of said seals or O-rings, against the support 4. In the clamped angular position of FIG. 2, the two clamping surfaces 32 and 34 shall rest against each other. To assemble the spraying implement 2 to and disassemble it from the support 4, the tightening element 26 is rotated into the angular position of separation of FIG. 1 wherein the clamping surfaces 32 and 34 are adjacent but not overlapping and the tightening element 26 may be displaced through the recess 36 by lifting the spraying implement 2 from the support 4, said recess 36, as already mentioned above, being subtended in this support.

Preferably the tightening element 26 is fitted with a manual-operation handle 40 in order to eliminate the need for a tool such as a screwdriver or a wrench to assemble the spraying implement 2 to or disassemble it from the support 4.

The handle 40 runs transversely to the axis of rotation 28 and preferably beyond the support 4 whereby said handle may be actuated outside said support and next to the spraying implement 2 for the purpose of clamping or releasing said spraying implement. In the preferred embodiment of the present invention, the recess 36 is a slot comprising an open end transverse to the axis of rotation 28, the handle being able to pass through said open end on account of the assembly motion of the spraying implement 2 and the support 4.

The angular range through which the tightening element 26 is rotated between the angular position of clamping of FIG. 2 and the angular position of separation of FIG. 1 may be small, for instance merely 10°. The angle of rotation is less than 360°, preferably even less than 180°. In the shown embodiment it is only about 70°.

In the preferred embodiment of the invention, a latch 42 is situated radially away from the axis of rotation 28 beyond at least one of said seals and keeps the spraying implement 2 parallel to the said axis of rotation and against the support 4. The spraying implement 2 and the support 4 can be joined into each other transversely to the axis of rotation at said latch 42 before they are tightened to each other in the longitudinal direction of the axis of rotation 28. Preferably the latch 42 shall be situated relative to the axis of rotation 28 radially outside the region of the seals 8-3 through 12-3.

During assembly, the spraying implement 2 and the support 4 are joined at the latch 42 transversely to the axis of rotation 28 as indicated in FIG. 1. The handle 40 then assumes the angular position of separation shown in FIG. 1. Thereupon the tightening element 26 is tightened into the spray system shown in FIG. 2 by the clamping surfaces 32 and 34 against the spring force of the seals 8-3 through 12-3 against the support 4.

The latch 42 is fitted at the spraying implement 2 with a latch surface 50 at a first protrusion or offset 48 pointing away from the axis of rotation 28, said surface 50 pointing in the direction opposite that of the fluid transmitting duct ends 8, 9, 10, 11 and 12, said first latch surface 50 engaging underneath the bottom of a second latch surface 52 constituted at an oppositely directed offset or protrusion 54 of the support 4 and pointing in a direction opposite that of its fluid transmitting duct ends 8-1, 9-1, 1O-1, 11-1 and 121. The second offset 54 points toward the axis of rotation 28 and its second latch surface 52 points in the longitudinal direction of the axis of rotation.

Preferably the latch 42 shall be situated at the rear end and the tightening element 26 with the tightening element 28 shall be situated at the front end of the spraying implement 2.

The latch 42 and the tightening element 26 are configured at sites where they do not interfere with the fluid-transmitting ducts. The axis of rotation 28 may be configured within or without the array of the fluid-transmitting duct ends 8 through 12 and 8-1 through 12-1. Uneven stressing of the seals 8-2 through 12-2 may be at least partly compensated by the latch 42. The latch 42 requires no locking elements to lock the spraying implement 2 to the support 4. The latch 42 prevents, or at least reduces, detaching the spraying implement 2 off the support 4, that is, it keeps the spraying implement “down” on the support 4. This simplified description also applies to embodiment modes wherein the spraying implement 2 is mounted underneath or next to the support 4.

The latch 42 is constituted between the spraying implement 2 and the support 4 and preferably it shall be integral with both components. Said range points transversely to the axis of rotation 28 for the purpose of interconnecting the spraying implement 2 and the support 4 transversely to said axis of rotation when the clamping surfaces 32, 34 assumes their non-overlapping positions of separation The latch 42 and the tightening element 26 are radially offset from each other with respect to the axis of rotation 28 at a distance beyond the seals. In other embodiments, the latch 42 may be divided into two components configured in mutually opposite and diametrical manner relative to the axis of rotation 28.

The latch surface 50 of the spraying implement 2 runs in a direction which is opposite that of said implement's fluid transmitting duct ends 8, 9, 10, 11 and 12. The latch surface 52 of the support 4 runs in the opposite direction of said surface's fluid transmitting duct ends 8-1, 9-1, 1O-1, 11-1 and 12-1.

The latch 42 preferably is mounted transversely to the axis of rotation 28 outside the zone of the fluid transmitting duct ends.

Preferably the axis of rotation 28 is configured transversely and in a direction opposite to it like the latch 42 outside the center of the totality of the fluid transmitting duct ends 8 through 12 and 8-1 through 12-1.

Preferably the position of the latch surfaces 50 and 52 relative to the transmitting fluid-transmitting duct ends and to the seals is selected in a manner that no gap arises, or only a gap of 1.0 mm or preferably of 0.5 mm or less shall arise between the mutually overlapping latch surfaces 50, 52 when the spray implement 2 and the support 4 and the seals 8-3, 9-3, 1O-3, 11-3, 12-3 between them are superposed without being compressed by the tightening element 26.

Preferably the seals 8-3 through 12-3 only project by 0.1 to 0.3 mm above the surfaces 44 and 46 respectively of the spraying implement 2 and support 4 wherein they are countersunk. Preferably they shall be compressed only little by the clamping of the tightening element 26. Three embodiment variations are feasible. In the first variation, the latch surfaces 50, 52 are separated by only a slight gap less than 1.0 mm when the spraying implement 2 and the support 4 and the seals between them rest on each other in the absence of clamping by the tightening element 26. In this case the gap preferably is only 0.1 to 0.3 mm. As a result, when the two said parts are joined in the latch 42, that part not receiving the seals shall reliably be precluded from damaging the seals by one of its edges. Nevertheless the latch 42 contributes to keeping both the spraying implement 2 and the support 4 together in fluid-tight manner even when external forces are exerted. In the second variation the said gap is 0.0 mm. In this case too abrasion caused by one part, for instance the support 4, on the seals, may be averted provided the spraying implement 2 and the support 4 shall be joined in careful manner. In the third variation the gap is less than 0.0 mm, and consequently, when the tightening element 26 is released, the joined parts, namely the spraying implement 2 and the support 4, shall be configured by the latch 42 to be obliquely rising on that seal which is nearest said latch and shall be moved into a mutually more parallel configuration when said two parts are clamped together by the tightening element 26, said two parts in said latter configuration resting in fluid-tight manner on all seals and assuring leakage-proof sealing at said seals even at high fluid pressures. In this third variation again the spraying implement 2 and the support 4 can be joined without damaging the seals.

1. A spray-coating system containing a spraying implement (2), a support (4) to which said spraying implement (2) may be detachable affixed using clamping means (6), further containing fluid-transmitting duct ends (8-1, 9-1, 1O-1, 11-1, 12-1) of fluid-transmitting ducts running in the support (4), said fluid-transmitting duct ends (8-1, 9-1, 1O-1, 11-1, 12-1) being configured opposite fluid-transmitting duct ends (8, 9, 10, 11, 12) of fluid-transmitting ducts in the spraying implement (2) in order to transmit fluid between them when the spraying implement (2) is affixed to the support (4), further containing seals (8-3, 9-3, 1O-3, 11-3, 12-3) at the fluid-transmitting duct ends to mutually seal the support (4) and the spraying implement (2), the spraying implement (2) being clampable by the clamping means (6) against the support (4) and in this process the in-between seals (8-3, 9-3, 1O-3, 11-3, 12-3) being compressible, characterized in that
the clamping means (6) contain a tightening element (26) which is affixed to and rotatable about the spraying implement (2) or affixed to and rotatable about the support (4) and which comprises a first clamping surface (32), in that a second clamping surface (34) is present at the particular other of the two parts of the group of spraying implement (2) and support (4), in that the axis of rotation of (28) of the tightening element (26) runs in the direction of clamping in which the spraying implement (2) and the support (4) can be clamped, and in that by rotating the tightening element (26) relative to said two parts (2, 4) the first clamping surface clamping the second clamping surface is rotatable jointly with it in order to clamp the spraying implement (2) against the support (4) and in the process to compress the in-between seals (8-3, 9-3, 1O-3, 11-3, 12-3).

2. Spray-coating system as claimed in claim 1, characterized in that at least one of the two clamping surfaces (32, 34) extends around the axis of rotation (28) over an angular range of less than 360° and in that the particular other clamping surface extends over less than the remaining angular range around the axis of rotation (28), in that the tightening element (26) is rotatable relative to the spraying implement (2) and relative to the support (4) between on one hand an angular position of separation wherein the clamping surfaces (32, 34) are configured in adjacent and non-overlapping angular ranges and on the other hand the angular position of clamping wherein the two clamping surfaces (32, 34) overlap at least partly and can be clamped together, and in that the particular part, i.e. either the spraying implement (2) or the support (4) to which the tightening element (26) is not affixed, shall be fitted with a recess (36) which allows passage to the tightening element (26) affixed to one of the parts on account of the relative motion of assembly of the two parts and their fluid-transmitting duct ends (8, 8-1; 9, 9-1; 10, 1O-1; 11, 11-1, 12, 12-1) wherein the tightening element (26) is in the angular position of separation and the clamping surfaces (32, 34) may be moved in the longitudinal direction of the axis of rotation into a position wherein the rotation of the tightening element (26) shall clamp them together.

3. Spray-coating system as claimed in one of the above claims, characterized in that at least one of the clamping surfaces (32, 34) is rising like a thread in the direction toward the other clamping surface (32, 34) within a partial range around the axis of rotation (28).

4. Spray-coating system as claimed in one of the above claims, characterized in that the tightening element (26) includes a handle (40) for manual operation.

5. Spray-coating system as claimed in claim 4, characterized in that the handle (40) is a lever running transversely from the axis of rotation (28) and in that the lever's end away from said axis (28) projects beyond the other of the two parts of the group of spraying implement (2) and support (4), said other part being fitted with the second clamping surface (34) and said end being externally manually accessible.

6. Spray-coating system as claimed in one of the above claims, characterized in that the relative angle of rotation of the two clamping surfaces (32, 34) between their angular position of clamping and their non-overlapping position of separation is equal to or less than 180°.

7. Spray-coating system as claimed in one of the above claims, characterized in that a latch (42) is constituted between the spraying implement (2) and the support (4) and runs in an assembling direction of the spraying implement (2) and support (4) transverse to the axis of rotation (28) when the clamping surfaces (32, 34) assume their mutually non-overlapping angular positions of separation.

8. spray-coating system as claimed in claim 7, characterized in that the latch (42) and the tightening element (26) are configured radially to the axis of rotation (28) at a mutual distance that runs at least beyond one of the seals.

9. Spray-coating system as claimed in either of claims 7 and 8, characterized in that the latch (42) comprises a latch surface (50) constituted at the spraying implement (2) and a latch surface constituted at the support (4), said two latch surfaces being configured away from the axis of rotation and mutually opposite in the longitudinal direction of the axis of rotation, in that the latch surface (50) of the spraying implement (2)points in the direction opposite that of its fluid-transmitting duct ends (8, 9, 10, 11, 12), in that the latch surface (52) of the support (4) points in a direction opposite that of its fluid-transmitting duct ends (8-1, 9-1, 1O-1, 11-1, 12-1).

10. Spray-coating system as claimed in one of claims 7 through 9, characterized in that the latch (42) is configured at a radial distance from the axis of rotation (28) outside the array of fluid-transmitting duct ends.

11. Spray-coating system as claimed in one of claims 7 through 10, characterized in that the axis of rotation (28) is configured transversely to it in the opposite direction of that of the latch (42) outside the center of the totality of the fluid-transmitting duct ends (8 through 12, 8-1 through 12-1).

12. Spray-coating system as claimed in one of claims 9 through 11, characterized in that no gap or only a gap less than 1.0 mm, preferably less than 0.5 mm is subtended between the overlapping latch surfaces (50, 52) when the spray implement (2) and the support (4) and the seals (8-3, 9-3, 1O-3, 11-3, 12-3) between them are superposed in the absence of compression by the tightening element (26).

13. Spray-coating system as claimed in one of claims 9 through 12, characterized in that at least one of the latch surfaces (50, 52) is fitted with an offset or protrusion (48) running in the direction of the gap between the axis of rotation (28) of the tightening element (26) and the latch (42).
